(19) United States
(12) Patent Application Publication
(10) Pub. No.: US 2004/0138897 A1
(43) Pub. Date: Jul. 15, 2004

(54) System and method for selecting projects and allocating capacity to departments to maximize incremental value gained within a desired level of execution risk

(76) Inventor: Gill R. Eapen, Groton, CT (US)

Correspondence Address: Gill R. Eapen, 94 Anchorage Circle, Groton, CT, 06340, US

(21) Appl. No.: 10/338,113

(22) Filed: Jan. 9, 2003

(51) Int. Cl. G06F 17/60

(52) U.S. Cl. 705/1; 705/7; 705/8

(57) ABSTRACT

The current invention is a method and system to select projects from available projects and to allocate resources to departments to maximize the incremental value gained within a desired execution risk. Probability distribution of departmental capacities is created by performing a Monte-Carlo simulation considering probabilities of future events that may increase or decrease capacity. Real options based value is calculated for all available projects at the start and end of the time period and a subset of the highest incremental value projects is selected to form a trial portfolio. Probability distribution of resource demand is created in each department through a Monte-Carlo simulation of the trial portfolio by specifying each project's resource needs. The capacity and demand characteristics are compared and an execution risk is calculated. If the execution risk is not within a desired level, projects in the trial portfolio are added, deleted or replaced or departmental capacities are changed such that the execution risk is brought to the desired level. At the end of this iterative process, the best possible selection of projects as well as the best possible allocation of capacities to departments are obtained and reported.

### BACKGROUND OF THE INVENTION

The invention relates generally to the field of project selection and capacity allocation (budgeting) in organizations. More particularly, the invention relates to a method and system to select a portfolio of projects from all available projects and to allocate capacity to departments, specialties, groups, and locations and skills (all together referred to as ‘department’) to maximize the incremental value gained by the organization within a desired execution risk. ‘Project’ refers to all possible investment opportunities available in all areas including R&D, Marketing, Manufacturing, Infrastructure, Administration etc. ‘Resource’ refers to skilled people, capital, space, machines, time etc. ‘Resource demand ’ refers to the need for resources. ‘Capacity’ refers to the availability of resources within departments. ‘Incremental value’ refers to the additional value gained by executing a project within a time period. ‘Execution risk’ refers to the probability that capacity may not be available to meet the resource demand. ‘Portfolio’ refers to a subset of selected projects from all available projects.

### CROSS REFERENCE TO RELATED APPLICATIONS

Corporate managers as well as investment managers of real estate, commodities, financial securities and venture capital often struggle to select the best projects from available projects and to allocate resources to departments in a manner that not only maximizes the incremental value gained by the organization but also assures that the selected projects can be executed by departments of limited capacity. To assure that the best projects are selected and resources are allocated to the departments appropriately, managers need to understand what resources are needed to execute the projects, what capacity may be available in the departments and what incremental value can be gained by the execution of the projects. The problem is not only selecting a portfolio of projects with the highest incremental value but also assuring that the resource demand can be met within each department with an acceptable level of execution risk. Although most organizations go through a formal annual, semi-annual or quarterly budgeting process, the allocation of capacities to departments often is ad-hoc rather than analytical. There are three primary reasons for this:

(a) Because of the inherent uncertainty in projects, a deterministic derivation (resulting in one estimation) of resource demand and execution capacity does not provide enough information for optimal allocation of capacity to departments. A probabilistic method and system are needed to accomplish this. Such a method and system are not often available.

(b) Incremental value gained from projects that show uncertainty and decision flexibility cannot be derived from traditionally available techniques such as Discounted Cash Flow (DCF). DCF results in an estimation of incremental value without consideration for the stochastic nature of the costs, benefits, events, timings and probabilities of success that drive project outcomes and without consideration for the flexibility, decision makers have to delay, abandon, expand and switch projects. A more generalized valuation methodology such as real options analysis is needed, but often is not practiced.

(c) Project selection and capacity allocation to departments need to be solved together (not independently). The method and system used to solve this must be extensible consistently across all projects and departments such that the project selection and capacity allocation can be solved for the organization globally. Additionally, the method and system must incorporate the needs articulated in (a) and (b). Such a method and system are not currently available.

Because of these and other organizational issues, management judgment is applied in lieu of analytical methods in selecting projects and allocating resources to departments for the execution of selected projects. Although some organizations have taken the steps to forecast resource demand probabilistically, none have created and implemented a selection and allocation method and system that takes into account the inherent uncertainty of resource demand and execution capacity and the stochastic and decision factors that drive value of projects.

The current invention provides a method and system to allocate resources considering probabilistic demand, probabilistic capacity and valuation based on real options analysis in such a way that incremental value to the organization is maximized within a desired level of execution risk. This is unique and significantly improves existing processes of project selection and capacity allocation (budgeting).

The related art is represented by the following references of interest.

U.S. Pat. No. 6,430,542, issued on Aug. 6, 2002 to William J. Moran, describes a computer-implemented program for financial planning and advice system. The William J. Moran patent does not suggest a system and method for selecting projects and allocating resources to departments according to the current invention.

U.S. Pat. No. 6,418,420, issued on Jul. 9, 2002 to Rinaldo DiGiorgio, et.al, describes a distributed budgeting and accounting system with secure token device access. The Rinaldo DiGiorgio patent does not suggest a system and method for selecting projects and allocating resources to departments according to the current invention.

U.S. Pat. No. 5,920,848, issued on Jul. 6, 1999 to Daniel Schutzer, et.al, describes a method and system for using intelligent agents for financial transactions, services, accounting, and advice. The Daniel Schutzer patent does not suggest a system and method for selecting projects and allocating resources to departments according to the current invention.

U.S. Pat. No. 5,911,134, issued on Jun. 8, 1999 to Ronald M. Castonguay, et.al, describes a method for planning, scheduling and managing personnel. The Ronald Castonguay patent does not suggest a system and method for selecting projects and allocating resources to departments according to the current invention.

U.S. patent application Publication No. 20020161678 A1, published on Oct. 31, 2002 for Max Jaffe, describes a method and medium for budgeting. The Max Jaffe application does not suggest a system and method for selecting projects and allocating resources to departments according to the current invention.

U.S. patent application Publication No. 20020152305 A1, published on Oct. 17, 2002 for Gregory J. Jackson; et.al, describes a method and medium for budgeting. The Gregory J. Jackson application does not suggest a system and method for selecting projects and allocating resources to departments according to the current invention.

U.S. patent application Publication No. 20020133444 A1, published on Sep. 19, 2002 for Sarat C. Sankaran; et al., describes an Interactive method and apparatus for real-time financial planning. The Sarat C. Sankaran application does not suggest a system and method for selecting projects and allocating resources to departments according to the current invention.

U.S. patent application Publication No. 20010039521 A1, published on Nov. 8, 2001 for Anna J Mattson; et al., describes a budget information and analysis system and method. The Anna Mattson application does not suggest a system and method for selecting projects and allocating resources to departments according to the current invention.

U.S. patent application Publication No. 20020059171 A1, published on May 16, 2002 for Bredt Donald Martin describes a method and system for resource planning and management. The Bredt Donald Martin application does not suggest a system and method for selecting projects and allocating resources to departments according to the current invention.

U.S. patent application Publication No. 20020026393 A1, published on Feb. 28, 2002 for Anna J. Mattson; et.al, describes a budget information, analysis, and projection system and method. The Anna J. Mattson application does not suggest a system and method for selecting projects and allocating resources to departments according to the current invention.

World Intellectual Property Organization Patent Application Publication No. WO 02/33873 A1, published on Oct. 18, 2001, describes a system and method for financial planning. The WIPO application does not suggest a system and method for selecting projects and allocating resources to departments according to the current invention.

None of the above inventions and patents, taken either singularly or in combination, is seen to describe the current invention as claimed. Thus a system and method for selecting projects and allocating resources to departments according to the current invention is desired.

### SUMMARY OF THE INVENTION

The current invention is a method and system to select projects from available projects and to allocate resources to departments to maximize the incremental value gained within a desired execution risk. According to one aspect of the present invention, the probability distribution of available capacity in each department is created using the Monte-Carlo simulation technique. Another aspect of the invention is the calculation of incremental value gained from each project using real options analysis. Another aspect of the invention is the creation of resource demand for the portfolio of selected projects at the department levels using the Monte-Carlo simulation technique. Yet another aspect of the invention is the selection of projects as well as allocation of capacity to departments in such a way that the incremental value gained by the organization is maximized within a desired level of execution risk.

The method of selecting projects and allocating resources to departments according to the current invention comprises of the following steps:

(a) A Monte-Carlo simulation is performed for each department to create a probabilistic capacity profile for the period selected. This requires inputs of current capacity as well as the probability characteristics of future events (such as new plant coming on line, hiring lag etc.) and their associated impacts on departmental capacity.

(b) The value of the project is calculated at the beginning and end of the time period considered. The difference between the end and the beginning value is the incremental value gained by executing the project. Because of the stochastic nature of costs, benefits, timings, events and probabilities, a real options analysis is needed to accomplish this.

(c) Projects are ranked from the highest incremental value to the lowest incremental value and a portfolio is formed selecting a subset of projects with the highest incremental value.

(d) The resource demand of the portfolio in each department is calculated by a Monte-Carlo simulation of the selected projects by specifying the resource needs at the project level probabilistically. These may depend on the type of project, the activities expected to be undertaken at the project level, timing of activities and the probability of success of the project.

(e) Resource demands are compared against departmental capacities calculated in (a), to create a measure of execution risk. Execution risk is defined as the probability that a department (or group of departments) will not have enough capacity to meet the resource demands from the selected portfolio of projects.

(f) If the execution risk of the selected portfolio is higher than a desired value (such as 5% probability that enough capacity will not exist to execute the portfolio of selected projects), then projects are deleted or replaced with other ones such that the execution risk is brought within the desired value. Alternately, departments that show capacity limitations can be allocated additional resources to increase capacity and reduce execution risk. These can be either the addition of new capacity or transfer of available capacities from those departments that may have excess capacity. If the execution risk is too low, projects may be added, starting with the highest incremental value projects from the remaining available projects.

(g) The process is continued till the execution risk is in the desired range.

At the end of the process, the results show both the best projects to select from available projects as well as the best allocation of capacity into departments to execute the selected projects such that the incremental value gained by the organization is maximized with a desired level of execution risk.

The system to select projects from available projects and to allocate resources to departments to maximize the incremental value gained by the organization within a specified execution risk, includes a computer system configured for carrying out the present invention.

The computer system may include any type of known computer, such as a personal computer or the like. Alternatively, the computer system may be functioning as a server/database of web site via the internet. A computer system configured for carrying out the present invention may include a computer, input devices, a display, and a printer. The computer may include a power interface, a central processing unit (CPU), a memory, a user interface(s), a network interface, a display, and a printer, that are all communicatively interconnected by a communication bus.

The memory may include random access memory (RAM) and read only memory (ROM). The ROM stores computer readable program code means that is read and processed by the CPU, and that causes the CPU to perform programmed functions. Movement and process of instructions as well as data is controlled and accomplished by the CPU. The RAM and the ROM may be connected to the microprocessor through several signal paths.

The CPU may execute various programs under the control of the operating system of the computer. Any computer readable program code means stored in the memory of the computer, or a computer useable medium having computer readable code embodied thereon may include means for the following:

(a) Provide an input mechanism for specifying the probabilistic characteristics of the events that affect available capacity of resources within departments

(b) Perform a Monte-Carlo simulation to create the probability distribution of departmental capacities

(c) Conduct a real options analysis of each project to calculate the value of the project at the start and end of the time period considered. This is based on the stochastic characteristics of project costs, benefits, timings, events and probabilities as well as the decision flexibility that may exist in all future decisions on the project.

(d) Create an output that shows the projects and incremental values in a descending fashion so that a subset of highest incremental value projects can be selected from all available projects.

(e) Provide an input mechanism for specifying the probabilistic characteristics of resource demand at the project level based on project attributes such as the type of the project, the activities expected to be undertaken at the project level, timing of activities and the probability of success of the project.

(f) Perform a Monte-Carlo simulation of all the projects, and create a probabilistic resource demand for all departments.

(g) Create an execution risk considering the probabilistic capacities (from b above) of departments and the probabilistic resource demands (from g above) for the departments.

(h) Create an output that shows resource demand, execution capacity and execution risk in all departments.

(i) Provide an input mechanism to make portfolio adjustments by adding, deleting and replacing projects or adding, deleting and replacing departmental capacities such that the calculated execution risk is equal to the desired value.

(j) Report selected projects and incremental value gained.

(k) Report resource demand and capacity in each department based on the selected portfolio of projects.

### BRIEF DESCRIPTION OF THE DRAWINGS

FIG. 1 is a front perspective view of a computer system equipped with computer readable program code means for valuing investment opportunities according to the present invention.

FIG. 2 is a block diagram of a computer system equipped with computer readable program code means for valuing investment opportunities according to the present invention.

### DETAILED DESCRIPTION OF THE INVENTION

The current invention is a method and system to select projects from available projects and to allocate resources to departments to maximize the incremental value gained within a desired execution risk. The invention disclosed herein is, of course, susceptible to embodiment in many different forms. Shown in the drawings and described herein below in detail are preferred embodiments of the invention. It is to be understood, however, that the present disclosure is an exemplification of the principles of the invention and does not limit the invention to the illustrated embodiments.

The method of the current invention has the following attributes:

(a) Representation of future events that may affect departmental capacities probabilistically. These may be probability distributions of finding people with the needed skills, time needed to complete new construction of buildings or machinery, chance of regulatory changes limiting the use of certain machinery, space or technology, chance of geopolitical events that may make availability of certain capacity more plenty or scarce, chance of climate changes and weather disturbances that may make availability of certain capacity more plenty or scarce. Any such event can be represented probabilistically using standard statistical representations and numerical techniques

(b) Calculation of the value of a project using real options analysis. Real options analysis is a known methodology for valuation when uncertainty and decision flexibility are present. This methodology is employed to calculate the incremental value gained from executing a project. The value of the project is calculated at the start and end of the selected time period. The difference between the start and end value is the incremental value gained by executing the project. In calculating the value of the project using real options analysis, the stochastic characteristics of the drivers of project value such as costs, benefits, events, timings and probabilities of success as well as the decision flexibility that may exist such as ability to delay, expand, abandon and switch need to be considered. Any available real options methodology can be employed to accomplish this.

(c) Representation of the resource demand in a department due to a single project, based on the characteristics of the project. These may be the time needed to complete certain activity, the probability distribution of resources needed to complete an activity, the chance of success of completing the activity, probability of competititor, buyer and supplier actions that may increase or decrease resource demand, probability of regulatory actions that may increase or decrease resource demand and the like. The resource demand that a single project may create in a department can thus be represented in a group of probability distributions.

(d) Monte-Carlo simulation of departmental capacities taking into account the factors described in (a) and of resource demands in departments taking into account factors described in (c). This is a well known methodology to create the aggregate probabilistic effect from many probabilistic drivers.

(e) Calculation of execution risk in a department. Execution risk is defined as the probability of having enough capacity in the department to meet the resource demand from the projects in the selected portfolio. From the probabilistic capacity obtained from (a) and the probabilistic demand obtained from (c), the combined probability that the capacity will be sufficient to meet demand can be calculated using standard statistical techniques and/or numerical methods. Alternately, this can be calculated using simulation employing the probability distributions derived in (a) and (c).

(f) Solving the project selection and capacity allocation together in one system by iteratively selecting projects to form a portfolio, calculating the execution risk of the portfolio and adjusting projects in the portfolio or capacity allocation in the departments to make the calculated execution risk equal to a desired level of risk. By giving preference to projects with the highest return and existing capacity in the departments, this methodology will assure that the solution results in the highest incremental value to the organization but at the same time keeps execution risk within a desired level. The execution risk can be estimated at each department independently (and assuring all departments are below the desired level of execution risk) or at the organization level (assuring the overall execution risk of the organization is below the desired level). It is also possible to define execution risk as a complex function of the departmental execution risks. It is solely up to the decision makers at the company to specify how the execution risk is to be determined, considering the circumstances that may be present.

The system of the current invention has the following attributes:

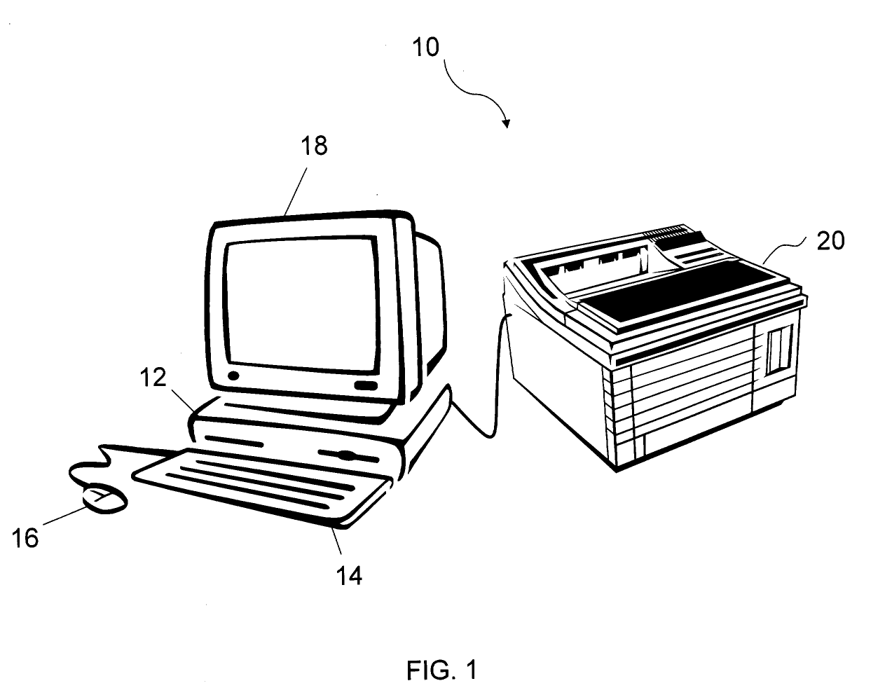

Referring to the drawings, FIG. 1 illustrates a system 10 that includes a computer system configured for carrying out the present invention. System 10 may include any type of known computer, such as a personal computer or the like. Alternatively, system 10 may be functioning as a server/database over the internet or local area network. As shown in FIG. 1, system 10 is configured for carrying out the present invention and includes a computer 12, input devices 14, 16, a display 18, and a printer 20. Input devices 14 and 16 are illustrated as a keyboard and a mouse, respectively. However, any input device may be employed according to the desires of the user. Display 18 may be any known display device, such as a cathode ray tube, a liquid crystal display, or the like. Printer 20 may be any known printing device. Additional components of an exemplary data visualization apparatus 10 comprising a digital computer are illustrated.

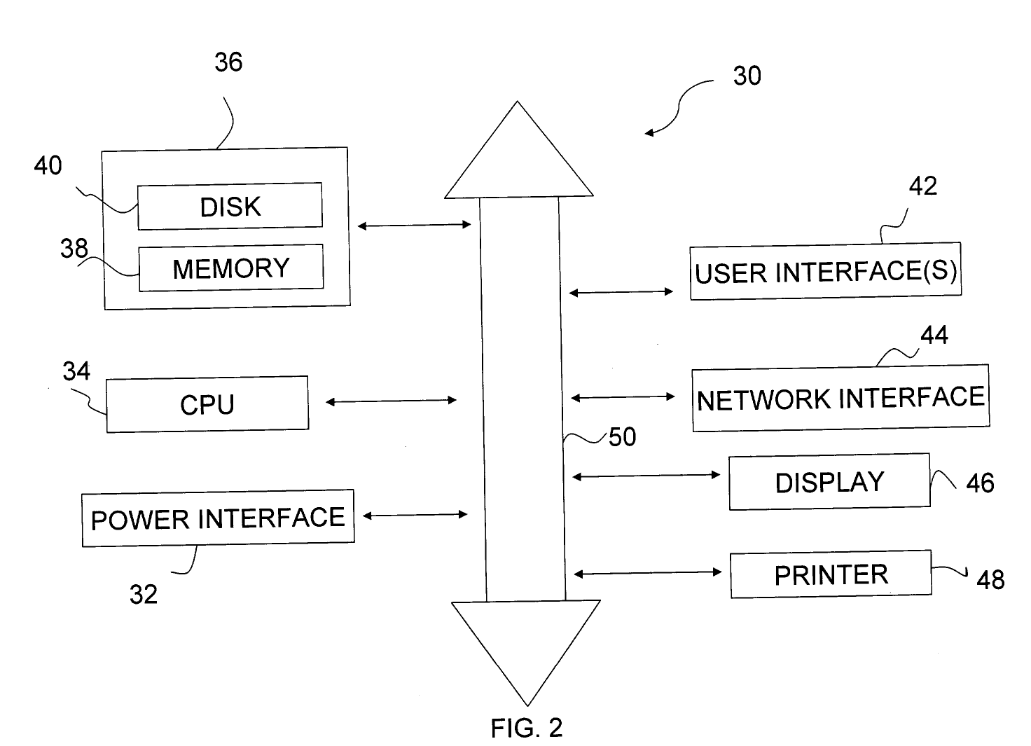

In FIG. 2, an illustrated configuration of a computer 30 includes a power interface 32, a CPU 34, a memory 36, a user interface(s) 42, a network interface 44, a display 46, and a printer 48, that are all communicatively interconnected by a communication bus 50. In the illustrated configuration, memory 30 includes memory 38 and disk storage device 40. Memory 30 represents computer useable media configured to store computer readable program code means and data. Exemplary memory 38 includes RAM and ROM. Exemplary disk storage devices 40 may include floppy disks, hard disks, CD-ROM devices, or the like.

The ROM stores computer readable program code means that is read and processed by CPU 34, and that causes CPU 34 to perform programmed functions. Movement and process of instructions as well as data is controlled and accomplished by CPU 34. The RAM and the ROM may be connected to the microprocessor through several signal paths.

CPU 34 may execute various programs under the control of the operating system of computer 30. The application program of the present invention may be configured for use with known graphical software applications, such as EXCEL™, ACCESS™ or the like. Any computer readable program code means stored in the memory of computer 30, or a computer useable medium having computer readable code means embodied thereon include the following features:

(a) Input mechanism for specifying the probabilistic characteristics of the events that affect available capacity of resources within departments.

(b) Monte-Carlo simulation engine to create the probability distribution of departmental capacities.

(c) Real options analysis engine to calculate the value of the project at the start and end of the time period considered. This is based on the stochastic characteristics of project costs, benefits, timings, events and probabilities as well as the decision flexibility that may exist in all future decisions on the project.

(d) Output mechanism that shows the projects and incremental values in a descending fashion so that a subset of highest incremental value projects can be selected.

(e) Input mechanism for specifying the probabilistic characteristics of resource demand at the project level based on project attributes such as the type of the project, the activities expected to be undertaken at the project level, timing of activities and the probability of success of the project.

(f) Monte-Carlo simulation engine to create a probabilistic resource demand for all departments.

(g) Execution risk calculator considering the probabilistic capacities (from b above) of departments and the probabilistic resource demands (from g above) for the departments.

(h) Output mechanism that shows resource demand, execution capacity and execution risk in all departments.

(i) Input mechanism that allows portfolio adjustments by adding, deleting and replacing projects or adding, deleting and replacing departmental capacities such that the calculated execution risk is equal to the desired value.

(j) Output mechanism that shows the selected projects and incremental value gained.

(k) Output mechanism that shows the resource demand and capacity in each department based on the selected portfolio of projects.

(l) Iteration logic to run appropriate Monte-Carlo simulation and real options analysis and report newer results when the portfolio is changed.

(m) Convergence logic that provides advice on when further changes in the portfolio does not substantially improve results.

An example of selecting projects from available projects and allocating resources to departments according to the current invention is discussed below.

As an example, an organization has 4 available projects, (P1,P2,P3,P4) and 3 departments (D1,D2,D3). There are three different resource types—Skilled people (FTE), Space (SPC), Machinery (MAC), External expenses ($) and the like. The projects will require various levels of resources in the departments.

Future events that may affect capacity in each department are identified and represented in a probabilistic way. For example if Department D1 is building a new facility and the probability of completion of the facility and the availability of additional capacity can be represented in a probability distribution such as “Poisson function.”

| Department | Event | Effect | Distribution |
|---|---|---|---|
| D1 | Plant | SPC | Poisson - Probability 15% |

Similar events that may affect the capacity of different resource types—skilled people, space, machinery, external expenses and the like—are represented for each department. A Monte Carlo simulation is conducted for each department and the probability distribution of expected capacity is determined. As an example, the results without units are given below—units will be appropriate to the resource type considered.

| Department | Type | Distribution | Mean | Variance |
|---|---|---|---|---|
| D1 | FTE | Lognormal | 100 | 25 |
| D1 | SPC | Lognormal | 50 | 10 |
| D1 | $ | Normal | 20 | 5 |
| D2 | FTE | Lognormal | 75 | 15 |
| D2 | SPC | Lognormal | 30 | 10 |
| - - - | | | | |

The incremental value of all available projects is determined using real options analysis. The stochastic nature of costs, benefits, events, timings and probabilities is considered for each project. Each project may be represented in a decision tree to show contingent decisions and associated decision flexibility. Real options analysis can be conducted using any of the available methods. The value of the project is calculated using real options analysis at the start and at the end of the considered time period. The incremental value is the difference in value.

| Project | Incremental value |
|---|---|
| P3 | 30 |
| P2 | 20 |
| P1 | 10 |
| P4 | 7 |

A trial portfolio is selected with the highest incremental value projects—P3 and P2.

The drivers of resources for each selected project are identified. As an example, activities that drive resources are identified for each project.

| Project | Drivers |
|---|---|
| P3 | Activity 1 |
| P2 | Activity 2 |

How the project activities affect resource demands in departments is specified. As an example, the FTE demand of activity 1 for each department is shown below. Similar information is needed for all resource types.

Activity 1, Project P3

| Department | FTE demand in Department |
|---|---|
| D1 | Lognormal with mean 20 and variance 100 |
| D2 | Lognormal with mean 10 and variance 10 |
| D3 | Lognormal with mean 15 and variance 40 |

The activities from all selected projects are represented in this fashion. Then a Monte Carlo simulation is performed to obtain resource demands in departments. As an example, the FTE demand for each department (considering all selected projects) is shown below. Similar results are needed for all resource types.

| Department | FTE demand |
|---|---|
| D1 | Lognormal with mean 120 and variance 400 |
| D2 | Lognormal with mean 75 and variance 900 |
| D3 | Lognormal with mean 40 and variance 100 |

An execution risk is calculated for each department by comparing the probability distribution of resource demand against probability distribution of available capacity. Execution risk is defined as the probability that the department will not have enough capacity to meet the resource demand. As an example, the execution risk for FTEs is shown for departments. Similar results can be obtained for all resource types.

| Department | FTE execution risk |
|---|---|
| D1 | 10% |
| D2 | 5% |

The execution risk is compared to the desired level. As an example, if the desired execution risk is 5%, department D1 has a risk higher than desired. In this case, projects may be deleted or replaced from the trial portfolio or capacity may be added to department D1 so that the execution risk can be brought down to 5%. Alternately, an overall execution risk for the entire company (including all departments) can be calculated and used as the measure for selecting the portfolio.

The process is repeated for all resource types and for all departments. The process is concluded when no further refinements can be made to increase the return of the portfolio without exceeding the desired execution risk. The results, including the selected projects and allocated capacities in each department, are then reported. As an example, the selected portfolio and the allocated capacities in the departments for FTEs are shown below. Similar results can be obtained for all resource types.

Selected portfolio

| Project | Return |
|---|---|
| P3 | 30% |
| P1 | 10% |

Allocated capacities

| Depart. | FTE | Expected capacity | Expected Demand |
|---|---|---|---|
| D1 | 90 | Mean 90, Variance 100 | Mean 95, Variance 400 |
| D2 | 50 | Mean 50, Variance 150 | Mean 60, Variance 100 |
| D3 | 20 | Mean 22, Variance 5 | Mean 20, Variance 10 |

Although the best results are obtained by applying the current invention to the organization as a whole, it is applicable to within segments of the organization separately, as well. In this case, locally optimal solutions can be obtained for each segment.

While the invention has been described with references to its preferred embodiment, it will be understood by those skilled in the art that various changes may be made and equivalents may be substituted for elements thereof without departing from the true spirit and scope of the invention.

I claim:

1. A method to select the best projects among all available projects within an organization, and allocate resources to departments and groups to maximize the incremental value gained by the organization within a desired execution risk.

2. A method of claim 1, wherein the probabilistic capacity at each department is determined through a Monte-Carlo simulation where the probabilistic occurrences of future events and associated probabilistic effects on departmental capacities are considered.

3. A method of claim 1, wherein the incremental value from each project is calculated as the difference in project value at the start and end of the time period considered.

4. A method of claim 3, wherein the project value is determined using real option analysis that considers the stochastic characteristics of costs, benefits, timing, events and probabilities as well as the flexibility in contingent decisions in the future.

5. A method of claim 1, wherein the probabilistic demand of resources at each department is created through a Monte-Carlo simulation of selected projects where each project has a specified probabilistic resource need based on its characteristics.

6. A method of claim 5, wherein the resource needs of each project in each department is defined probabilistically based on the characteristics of the project such as type of project and activities to be performed in the project.

7. A method of claim 1, wherein a portfolio of projects are selected from all available projects iteratively to maximize the incremental value gained by the organization within a specified execution risk.

8. A method of claim 1 and 7, wherein the execution risk is calculated as the probability of not having enough capacity in a department or group of departments to execute the portfolio of selected projects.

9. A method of claim 1 and 7, wherein the selection of the projects is made in conjunction with the allocation of capacity to departments.

10. A system to select the best projects among all available projects within an organization, and allocate resources to departments and groups to maximize the incremental value gained by the organization within a desired execution risk, comprising of:
a central processing unit;
a memory;
an output device;
computer readable program code means stored in said memory, said computer readable program code in a machine-readable medium having stored thereon data representing sequences of instructions, the sequences of instructions which, when executed by a processor, cause the processor to perform the steps of selecting projects and allocating resources to departments/specialty such that the overall return to the company is maximized within a desired level of execution risk.

11. The machine-readable medium of claim 10, wherein the probabilistic capacity at each department is determined through a Monte-Carlo simulation where the probabilistic occurrences of future events and associated probabilistic effects on departmental capacities are considered.

12. The machine-readable medium of claim 10, wherein the incremental value from each project is calculated as the difference in project value at the start and end of the time period considered.

13. The machine-readable medium of claim 12, wherein the project value is determined using real option analysis that considers the stochastic characteristics of costs, benefits, timing, events and probabilities as well as the flexibility in contingent decisions in the future.

14. The machine-readable medium of claim 10, wherein the probabilistic demand of resources at each department is created through a Monte-Carlo simulation of selected projects where each project has a specified probabilistic resource need based on its characteristics.

15. The machine-readable medium of claim 14, wherein the resource needs of each project in each department is defined probabilistically based on the characteristics of the project such as type of project and activities to be performed in the project.

16. The machine-readable medium of claim 10, wherein a portfolio of projects are selected from all available projects iteratively to maximize the incremental value gained by the organization within a specified execution risk.

17. The machine-readable medium of claim 10 and 16, wherein the execution risk is calculated as the probability of not having enough capacity in a department or group of departments to execute the portfolio of selected projects.

18. The machine-readable medium of claim 10 and 16, wherein the selection of the projects is made in conjunction with the allocation of capacity to departments.
